(19) United States
(12) Patent Application Publication
(10) Pub. No.: US 2006/0162651 A1
(43) Pub. Date: Jul. 27, 2006

(54) Blade coating apparatus and printing surface coating apparatus for a disk

(75) Inventors: Shinsuke Takahashi, Kanagawa (JP); Takayoshi Ose, Kanagawa (JP); Satoshi Matsubaguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/337,526

(22) Filed: Jan. 24, 2006

(30) Foreign Application Priority Data
Jan. 25, 2005 (JP) P. 2005-016972

(51) Int. Cl. B05C 3/00

(52) U.S. Cl. 118/406; 118/213

(57) ABSTRACT

A blade coating apparatus comprising: a mask having an opening, said mask being overlaid on a flat substrate to be coated; a blade movable relatively to said mask and above said mask to apply a coating liquid onto said mask so that a coating layer is formed on a coating surface of said flat substrate, said coating surface being exposed from said opening; and a water repellent portion which suppresses adhesion of the coating liquid, said water repellent portion being provided on an end face which defines said opening.

### FIELD OF THE INVENTION

The present invention relates to a blade coating apparatus for coating a coating liquid onto a flat substrate, and a printing surface coating apparatus for a disk which uses it.

### BACKGROUND OF THE INVENTION

Conventionally, as a method of coating a coating liquid onto a flat substrate, known are roll coating, gravure coating, and extrusion coating.

As another method of coating a coating liquid onto a flat substrate, known is a blade coating method disclosed in JP-A-5-220966.

In a conventional blade coating apparatus 1 shown in FIG. 8A, a flat substrate D is supported on a support member 2 which is vertically movable, and the support member 2 is moved to an upper position by a driving member 3 to attain a state where a mask 4 having an opening 4a is overlaid on a portion of the flat substrate D other than a coated portion. A long blade 5 is moved along the upper face of the mask 4 in the direction of the arrow A, whereby a coating liquid 6 supplied onto the mask 4 is scraped over, so that the coating liquid 6 is deposited on the coated portion exposed from the opening 4a. As a result, a coating layer 9 of the coating liquid 6 is formed on the flat substrate D.

For example, it has been requested that such a method can be applied as means for, in steps of producing a magnetic recording medium having a disk-like substrate, forming a printing surface on the substrate by means of blade coating (or doctor blade coating).

### SUMMARY OF THE INVENTION

In the method of the blade coating apparatus 1, as shown in FIG. 8B, the support member 2 is downward moved after the coating liquid is coated onto the flat substrate D, thereby performing a work of separating the substrate on which the coating layer 9 is formed, from the mask 4. At this time, a phenomenon sometimes occurs in which, as shown in FIG. 9, the coating liquid 6 threads between the coating layer 9 coated onto the flat substrate D and the coating liquid 6 deposited on the mask 4, and adheres to the end face of the opening 4a of the mask 4 and the like, and the adhering portion remains as an adhering liquid 6a. When the phenomenon occurs, there is fear in the next and subsequent coating steps that the adhering liquid 6a impedes the coating operation by the blade 5, or that the adhering liquid 6a is transferred to the upper face of the flat substrate D or the coating layer 9, thereby causing uneven thickness.

The invention has been conducted in view of the above-discussed circumstances. It is an object of the invention to provide a blade coating apparatus in which, after coating, it is possible to suppress adhesion and remaining of a coating liquid to a mask, and a printing surface coating apparatus for a disk using the blade coating apparatus.

The object of the invention is achieved by a blade coating apparatus comprising: a mask having an opening, the mask being overlaid on a flat substrate to be coated; and a blade movable relatively to the mask and above the mask to apply a coating liquid onto the mask so that a coating layer is formed on a coating surface of the flat substrate, the coating surface being exposed from the opening, wherein the blade coating apparatus further comprises a water repellent portion which suppresses adhesion of the coating liquid, the water repellent portion being provided on an end face which defines the opening.

In the blade coating apparatus of the invention, the water repellent portion is formed on the end face of the opening of the mask. When, after coating, the flat substrate is separated from the mask, therefore, adhesion of a coating liquid to the end face can be suppressed. In the subsequent coating operations, consequently, it is possible to prevent the coating from being impeded by a coating liquid on the end face, and also uneven thickness caused by transfer of a coating liquid on the end face to the upper face of the flat substrate or the coating layer, from occurring.

In the blade coating apparatus, preferably, the water repellent portion is a portion to which a fluorine coat is applied.

In the blade coating apparatus, preferably, a water contact angle of the water repellent portion is equal to or larger than 100°.

When the blade coating apparatus of the invention is used, it is possible to provide a printing surface coating apparatus for a disk which can form a printing surface that is free from unevenness of thickness and has an excellent flatness, by laminating the coating liquid on a disk-like recording medium.

According to the invention, it is possible to provide a blade coating apparatus in which, after coating, adhesion and remaining of a coating liquid to a mask can be suppressed, and a printing surface coating apparatus for a disk using the blade coating apparatus.

### BRIEF DESCRIPTION OF THE DRAWINGS

FIG. 1 is a perspective view showing an blade coating apparatus.

FIG. 2 is an enlarged section view of a blade.

FIGS. 3A, 3B and 3C show a procedure of a coating method according to the invention.

FIGS. 4D, 4E, 4F and 4G show the procedure of the coating method according to the invention.

FIG. 5 is a plan view of a coated member in which coating has been completed.

FIG. 6 is an enlarged section view showing the vicinity of an opening of a mask in the blade coating apparatus of the invention.

FIG. 7 is a view showing a modification of the blade coating apparatus of the invention.

FIGS. 8A and 8B illustrates a conventional blade coating apparatus.

FIG. 9 is a view showing a state where a flat substrate is separated from a mask.

### DESCRIPTION OF REFERENCE NUMERALS AND SIGNS

25 mask
26 water repellent portion
27 opening
49 coating liquid
100 blade coating apparatus
D disk (flat substrate)

### DETAILED DESCRIPTION OF THE INVENTION

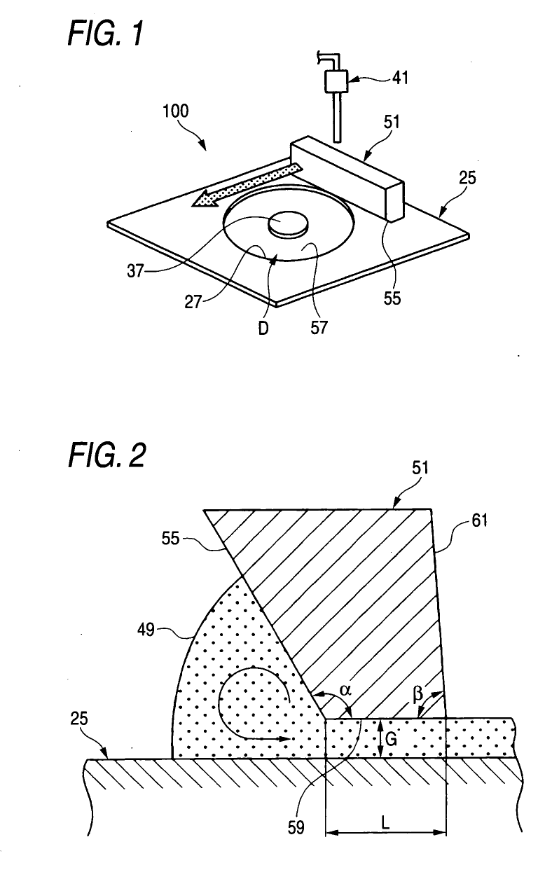

Hereinafter, an embodiment of the blade coating apparatus and a printing surface coating apparatus for a disk using it according to the invention will be described in detail with reference to the accompanying drawings. FIG. 1 is a perspective view showing an blade coating apparatus, and FIG. 2 is an enlarged section view of a blade.

The blade coating apparatus 100 is used for coating a coating liquid onto a flat substrate to form a coating layer. In the embodiment, as an example of the flat substrate, a disk-like recording medium (hereinafter, referred to also as disk) D is used as a coated member.

In the disk D, an opposite surface of a coating surface onto which the coating liquid is to be coated is supported by a support member which is not shown. The support member is configured so as to be vertically movable. When the disk D is to be transferred onto the support member, when the disk is to be unloaded from the support member after coating, or when coating is to be performed, for example, the flat substrate can be adjusted to a desired vertical position.

A plate-like mask 25 is disposed above the disk D. The mask 25 has an opening 27 from which a coating surface 57 is exposed. A coating layer in the upper face of the disk D is to be formed on the coating surface. In the embodiment, the opening 27 is formed into a circular shape having a diameter of about 120 mm. The shape of the opening 27 may have any shape corresponding to that of the coating layer to be formed on the disk D. The shape of the coating layer may be freely set by adequately changing the opening shape of the mask 25.

When the disk D is to be coated, the supported disk D is overlaid on the lower face of the mask 25, and held in a state where, in a bottom plan view, the outer peripheral edge of the disk D is overlaid on the peripheral edge of the opening of the mask 25.

A blade 51 is disposed above the mask 25. The blade 51 is a long member made of a metal material such as a stainless steel material. As shown in FIG. 2, the blade 51 is formed so that the section taken along a direction perpendicular to the longitudinal direction has a substantially trapezoidal shape.

The material of the blade 51 preferably has a chromium content which is not smaller than that of SUS316. According to the configuration, the wear resistance, the corrosion resistance, the heat resistance, and the mold release characteristics can be further improved.

The blade coating apparatus 100 comprises coating liquid supplying means 41 for supplying the coating liquid to the upper face of the mask 25. Before coating or in each coating, the coating liquid supplying means 41 supplies a predetermined amount of the coating liquid 49 to a portion between the opening 27 and the blade 51 in the upper face of the mask 25. The coating liquid supplying means 41 may be configured so that it is disposed as an apparatus other than the blade coating apparatus 100, and, in coating, the coating liquid is supplied to the upper face of the mask 25, or that the worker manually supplies the coating liquid onto the mask.

A gap G is formed between the blade 51 and the mask 25. The coating liquid 49 is pressed in accordance with the guidance of the flow by the front side face 55 of the blade 51, whereby the coating liquid is squeezed into the gap G.

Then, the coating liquid 49 passes over the distance L along a pressing face 59 which is formed in the lower end face of the blade 51 opposed to the coating surface 57, whereby the coating liquid 49 is filled into the opening 27 of the mask 25. In coating, as shown in FIG. 1, the blade 51 is moved along the surface over the mask 25 while the coating liquid 49 is pressed toward the opening 27 by the front side face 55, so that the coating liquid 49 is flatly coated onto the coating surface 57.

As the coating liquid 49, preferably, a coating liquid having a viscosity of 150 to 800 cP is used. Particularly preferably, a coating liquid having a viscosity of 200 to 700 cP is used.

The angle α formed by the pressing face 59 of the blade 51 and the front side face 55 is preferably set within the range of 110°≦α≦150°, and the angle β formed by the pressing face 59 of the blade 51 and a rear side face 61 is preferably set within the range of 60°≦β<100°. The gap G between the pressing face 59 of the blade 51 and the mask 25 is preferably set within the range of 20 μm≦G≦150 μm.

Next, a method of coating a coating liquid with using the blade coating apparatus 100 will be described.

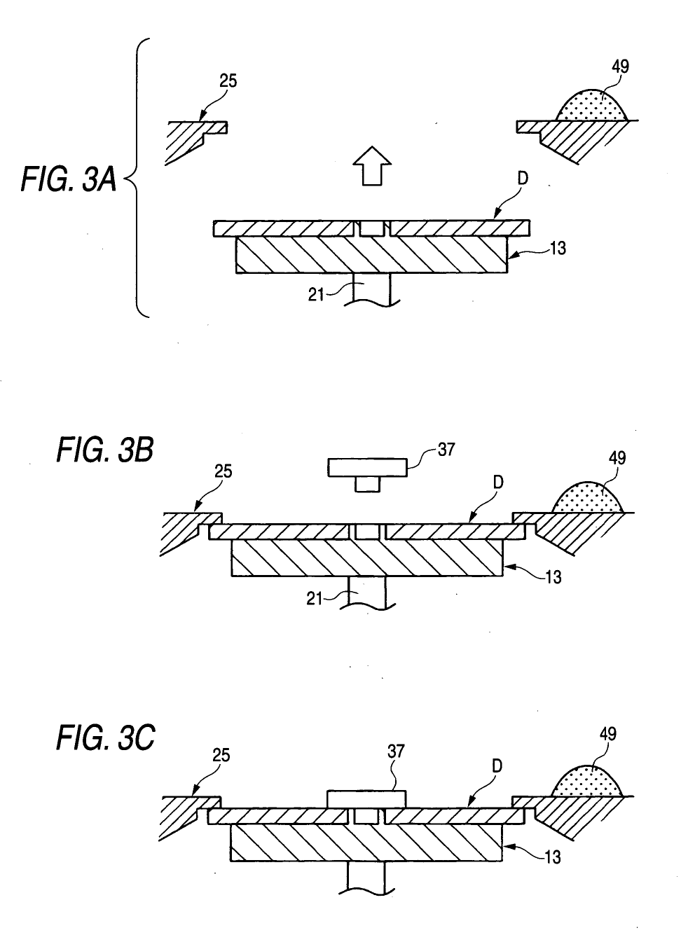

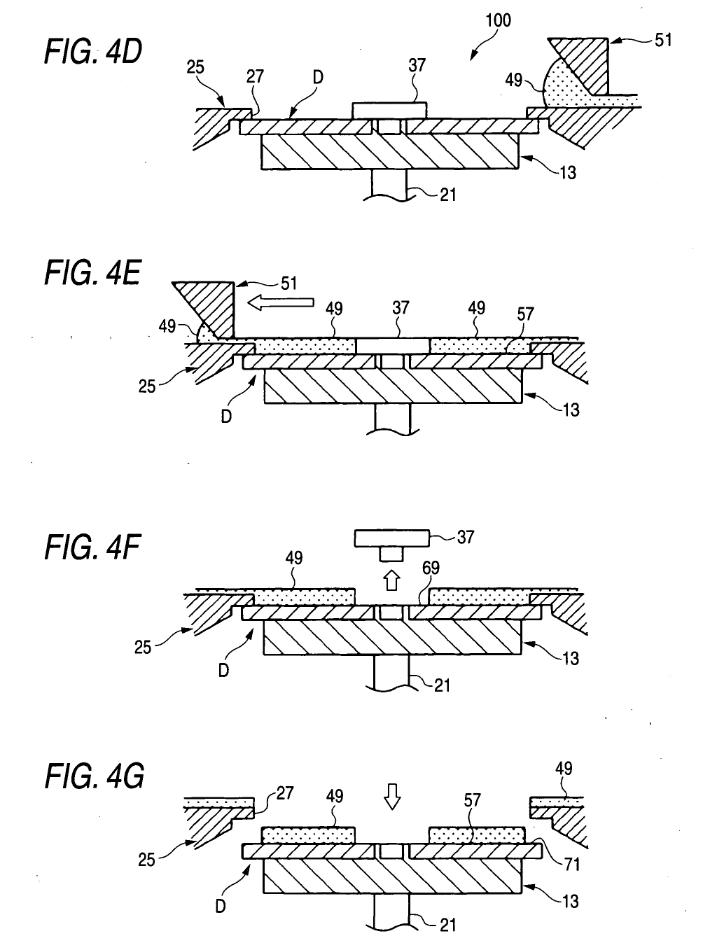

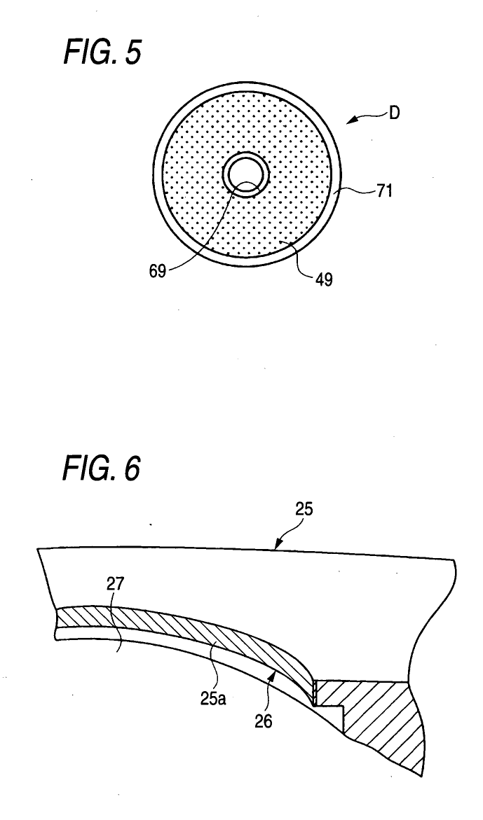

FIGS. 3A to 3C show the procedure of the coating method according to the invention, FIGS. 4D to 4G show the procedure of the coating method according to the invention, and FIG. 5 is a plan view of a coated member in which coating has been completed.

In the blade coating method, the coating liquid 49 is coated onto the coating surface 57 of the disk D which is exposed from the opening 27 of the mask 25, under the conditions that at least one of the straightness and the center line average surface roughness satisfies the above-mentioned conditions so that the blade 51 is set within the above-mentioned range.

First, the disk D is placed on a table-like support member 13, and, as shown in FIG. 3A, the support member 13 is raised to cause the disk D to butt against the opening 27 of the mask 25. As shown in FIGS. 3B and 3C, then, a mask cap 37 is inserted into a center hole of the disk D.

As shown in FIGS. 4D and 4E, thereafter, the coating liquid 49 is supplied onto the mask 25 by the coating liquid supplying means 41, and the blade 51 is moved by moving means from the right side in the figure to the left side, whereby the blade 51 is passed together with the coating liquid 49 over the coating surface 57 of the disk D to form a coating liquid layer of a predetermined thickness on the coating surface 57 of the disk D.

As shown in FIG. 4F, next, the mask cap 37 is detached from the disk D. This causes a circular step portion 69 onto which the coating liquid 49 is not coated, to be formed in a middle portion of the disk D. As shown in FIG. 4G, then, the support member 13 is lowered, and the disk D is separated from the opening 27 of the mask 25. This causes the coating liquid 49 coated onto the coating surface 57, to be separated from the coating liquid 49 on the mask 25. As a result, an uncoated portion 71 onto which the coating liquid 49 is not coated, and which is shown in FIG. 5 is formed in the outer peripheral edge of the disk D because the edge is covered by the mask 25.

The disk D onto which the operation of coating the coating liquid 49 has been completed in this way is detached from the support member 13, and then transferred to a coating liquid drying step which is the next step, and which is not shown.

FIG. 6 is an enlarged section view showing the vicinity of the opening 27 of the mask 25 in the blade coating apparatus 100.

On an end face 25a which defines the opening 27 in the mask 25, as shown in FIG. 6, a water repellent portion 26 which suppresses adhesion of the coating liquid 49 to the end face 25a is formed.

In the embodiment, the water repellent portion 26 is formed by applying a fluorine coat on the end face 25a of the opening 27. Preferably, the water repellent portion 26 in which the fluorine coating is performed has a coat thickness in the range of 5 to 20 μm. The fluorine resin to be used in the fluorine coating may undergo a surface treatment such as TUFRAM (registered trademark), NEDOX (registered trademark), or NIFGRIP (registered trademark) of ULVAC TECHNO, Ltd.

In the water repellent portion 26, it is preferable to set the contact angle showing the water repellency in the case where the coating liquid 49 is in contact with the portion, to be equal to or smaller than 110°.

In place of the configuration of the invention where the water repellent portion 26 is formed on the end face 25a of the opening 27 of the mask 25, alternatively, it may be contemplated to conduct an operation of wiping or washing the vicinity of the opening 27 after coating, as means for preventing the coating liquid from adhering to the end face 25a. However, the work burden is increased, and hence the alternative is not preferable. It may be contemplated to employ another configuration where the coating liquid 49 adhering to the end face 25a is sucked. However, this configuration is complicated, and hence not preferable. Furthermore, means for, after coating, applying a drying step on the mask 25 without separating the disk D, and, after the coating liquid 49 is sufficiently solidified, separating the disk D from the mask 25 may be contemplated. In this case, however, a plurality (a large number) of masks 25 must be prepared, and the apparatus is complicated. Therefore, it is not preferable.

In the blade coating apparatus 100 described above, the water repellent portion 26 is formed on the end face 25a of the opening 27 of the mask 25. When the disk D (flat substrate) is separated from the mask 25 after coating, therefore, adhesion of the coating liquid to the end face 25a can be suppressed. Therefore, it is possible to prevent the coating operation in the subsequent coating process from being impeded by the coating liquid on the end face 25a, and also uneven thickness caused by transfer of the coating liquid on the end face 25a to the upper face of the disk D or the coating layer, from occurring.

When a blade coating apparatus is used as in the embodiment, it is possible to obtain a printing surface coating apparatus for a disk which can form a printing surface that is free from unevenness of thickness, on a disk-like recording medium.

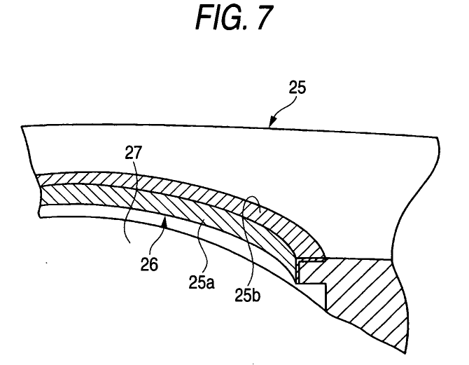

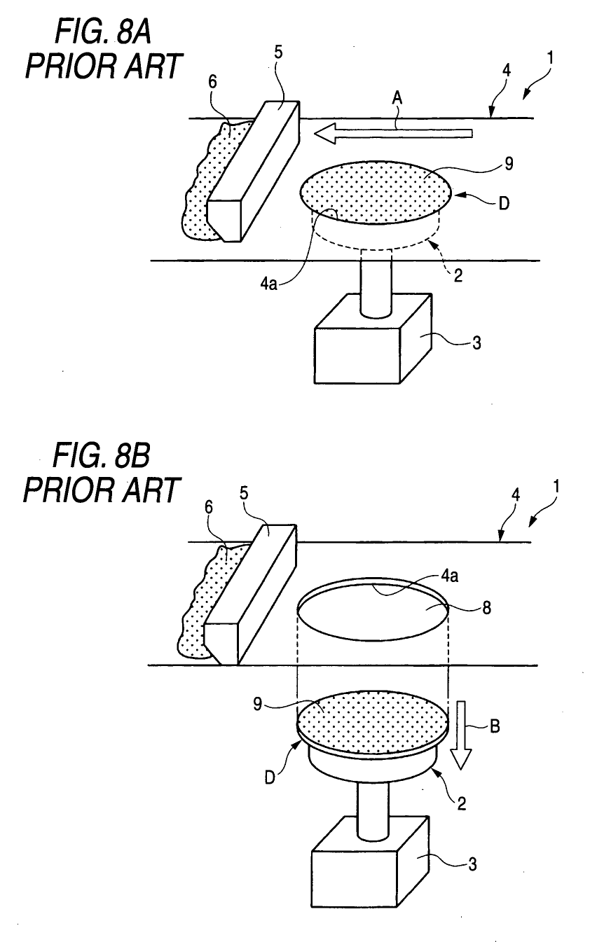

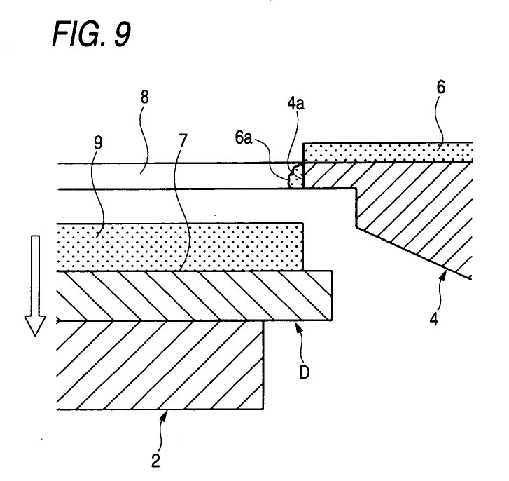

FIG. 7 is an enlarged section view showing a modification of the blade coating apparatus of the embodiment.

As shown in FIG. 7, the water repellent portion 26 may be formed not only on the end face 25a of the opening 27 of the mask 25, but also on an peripheral edge portion 25b of the opening on the upper face. According to the configuration, adhesion of the coating liquid 49 to the end face 25a can be suppressed, and moreover adhesion of the coating liquid 49 to the peripheral edge portion 25b of the opening 27 can be suppressed. In the case where coating is repeatedly performed, therefore, it is possible to more surely prevent adhesion liquid on the mask 25 from transferring to the upper face of the disk D or the coating layer to produce uneven thickness, or impairing the surface property of the coating layer.

This application is based on Japanese Patent application JP 2005-16972, filed Jan. 25, 2005, the entire content of which is hereby incorporated by reference, the same as if set forth at length.

What is claimed is:

1. A blade coating apparatus comprising:
a mask having an opening, said mask being overlaid on a flat substrate to be coated;
a blade movable relatively to said mask and above said mask to apply a coating liquid onto said mask so that a coating layer is formed on a coating surface of said flat substrate, said coating surface being exposed from said opening; and
a water repellent portion which suppresses adhesion of the coating liquid, said water repellent portion being provided on an end face which defines said opening.

2. The blade coating apparatus according to claim 1, wherein said water repellent portion is a portion to which a fluorine coat is applied.

3. The blade coating apparatus according to claim 1, wherein a water contact angle of said water repellent portion is equal to or larger than 100°.

4. The blade coating apparatus according to claim 2, wherein a water contact angle of said water repellent portion is equal to or larger than 100°.

5. A printing surface coating apparatus for a disk wherein at least one of printing surfaces of a disk-like recording medium is formed with using the blade coating apparatus according to claim 1.
